(19) United States
(12) Patent Application Publication
(10) Pub. No.: US 2003/0150962 A1
(43) Pub. Date: Aug. 14, 2003

(54) Method for controlling and delaying the separation of flow from a solid surface by suction coupling (controlling separation by suction coupling, CSSC)

(76) Inventor: Bela Orban, Placitas, NM (US)

Correspondence Address: Bela Orban, 24 Quail Meadow Road, Placitas, NM, 87043, US

(21) Appl. No.: 10/073,579

(22) Filed: Feb. 12, 2002

(51) Int. Cl. B64C 21/06

(52) U.S. Cl. 244/209

(57) ABSTRACT

A method to delay flow separation from a solid body in a fluid stream by coupling the region of the suction peak with the region of adverse pressure gradient. This method is particularly applicable for increasing the lift of a wing or for increasing the effectiveness of machines designed to move fluid or control fluid flow.

### CROSS-REFERENCE TO RELATED APPLICATIONS

Not Applicable.

### STATEMENT REGARDING FEDERALLY SPONSORED RESEARCH OR DEVELOPMENT

The claimed invention was not developed under federally sponsored research and development.

### REFERENCE TO A MICROFICHE APPENDIX

Not Applicable.

### BACKGROUND OF THE INVENTION

The subject invention relates to the control of the boundary layer flowing over a solid body such as a wing or turbine blade. The presented invention describes a method and apparatus to delay the separation of the boundary layer over a solid body. As the angle of attack of the flow with respect to the solid body increases, the suction peak above the body increases along with an increasing adverse pressure gradient opposing the flow along the upper surface of the body. The increasing angle of attack increases the lift generated on the body to a limit. When the angle of attack reaches a certain limit the adverse pressure gradient becomes too large for the flow to negotiate it. At this point the flow separates from the upper surface of the body resulting in a condition commonly known as stall. Stall substantially reduces the lift and increases the drag generated on the body. Delaying the onset of flow separation as the angle of attach increases beyond the uncontrolled stall angle substantially increases lift on the body while at the same time reduces the drag on the body.

### DESCRIPTION OF PRIOR ART

Since the early years of the 20th Century, laboratory research coupled with theoretical work by researchers such as Prandtl's fundamental research revealed the importance of the boundary layer and the need to control it. The first attempts to actively control the boundary layer were to apply steady suction or blowing over the surface of the body. These controls, especially suction, are very successful in the wind tunnel but require large amounts of power therefore negating the benefits in a practical application.

It has been established early on that suction applied in the adverse pressure region of the body is a very effective way to delay the flow separation. The suction acts in a similar manner as a pressure drop to stabilize the boundary layer. Suction decreases the boundary layer thickness and a thin boundary layer is less likely to transition to turbulence and separation.

There have been several more recent ideas to apply periodic excitation as opposed to steady suction or blowing to the surface of the body. One of the most recent of these methods is described in U.S. Pat. No. 5,209,438 by Wygnansky. Most of the methods proposed so far for boundary layer control require a source of energy and sophisticated controls.

### BRIEF SUMMARY OF THE INVENTION

The general idea of the claimed invention is to couple the naturally occurring suction peak with the adverse pressure region further downstream over a solid body in a fluid stream. The main advantages of this invention over previous attempts to control the boundary layer separation is its inherent simplicity and the lack of external power requirements.

As we understand it today, flow separation may occur in two different ways. One is when near the stall angle of attack, a large-scale separation bubble forms at the leading edge whose length is commensurate with the airfoil chord. As the angle of attack continues to increase, this separation bubble “bursts”, as the flow can no longer overcome the adverse pressure gradient. The other is when vortexes “roll up” from the trailing edge and propagate along the upper surface of the body toward the leading edge.

By coupling the suction peak with the higher pressure region downstream from the suction peak two favorable changes can be effected. First, the suction peak will be reduced by the introduction of a higher pressure and second, a reduction of the adverse pressure gradient by providing suction in that region. These changes in the pressure distribution over the solid body delay the onset of flow separation and the resulting stall therefore allow higher angles of attack and higher lift on the body than it would be possible without this invention. Since the two coupled regions are on the same side of the solid body, the total, integrated suction force over the surface (hence the lift) is not reduced only its distribution is changed.

In its simplest form, this invention does not require any outside source of power. However, it can be coupled with any other methods to introduce periodic or steady blowing or suction to increase the effectiveness of the boundary layer control.

### BRIEF DESCRIPTION OF THE SEVERAL VIEWS OF THE DRAWING

The attached drawings depict the proposed invention. List and description of figures:

FIG. 1 is the cross sectional view of an airfoil showing the suction peak and adverse pressure region perforations, the connecting channel between them and the controlling valve.

FIG. 1a is a close-up cross sectional view of the perforation area with the sliding cover open.

FIG. 1b is a close-up cross sectional view of the perforation area with the sliding cover closed.

### DETAILED DESCRIPTION OF THE INVENTION

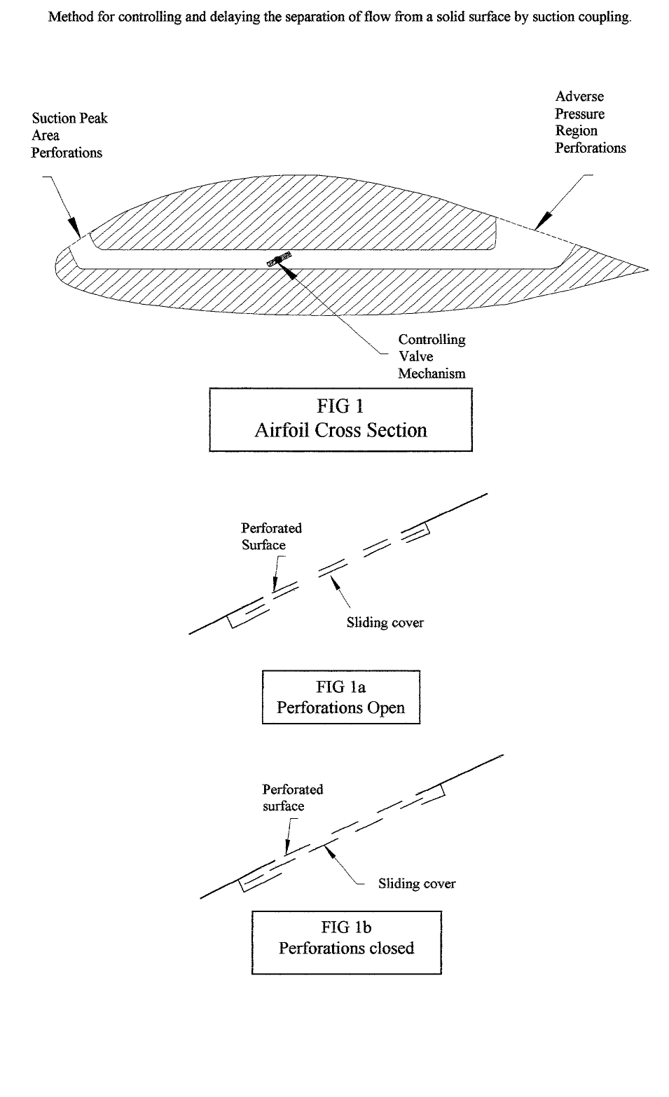

As illustrated in FIG. 1, the invention, in its most basic form, consists of two spanwise, perforated sections on the upper surface of the solid body connected with each other inside the body. There is a control valve mechanism regulating the coupling between the two perforated sections. FIG. 1a and FIG. 1b illustrate a sliding cover arrangement to open and close the perforations.

One section of the perforations is close to the leading edge of the body in the region of the suction peak. In the case of an airfoil, this location is within the first 15% of the airfoil's chord length in a region where the pressure minimum is generally located. The other perforated region is located upstream from the trailing edge and generally covers a much wider area than the perforations near the leading edge.

The exact location, width and optimum shape of the perforated regions can be established with wind tunnel measurements for each individual airfoil.

It is possible to increase the effectiveness of this invention with a calibrated vacuum reservoir at one or both perforated locations. This method would be especially effective for a pitching airfoil such as a helicopter blade. The reservoir can supply momentary fluid mass and momentum to delay or prevent flow separation at the point of sudden angle of attack change.

The claimed invention can also be coupled with other boundary layer control methods such as steady blowing or suction through the perforated regions. Various methods to introduce periodic excitation can also be used in combination with the claimed invention to increase the effectiveness and/or the range of control.

A mechanism as simple as a calibrated orifice or a butterfly valve or a more complex valve and control arrangement is used to moderate the coupling between the two regions. The optimum coupling control logic can be experimentally established for each airfoil and each desired angle of attack.

For some bodies, it may be desirable to have multiple perforated sections at one or both the leading and trailing edge region. Depending on the momentary flow conditions over the body, the appropriate perforated sections can be connected while the others are closed with the sliding covers or other suitable methods.

It is also possible to use permeable skin in place of perforations. U.S. Pat. No. 4,081,892 describes a method to create precision surface openings for boundary layer control.

The perforated sections can be closed with the sliding covers (FIG. 1a and FIG. 1b) during times when there is no need for the flow control or as a way to control the degree of coupling between the regions. The covers would also prevent the intrusion of foreign materials when the CSSC controls are inactive.

What I claim as my invention is:

1. A method to delay the separation of the flow from a solid body beyond an angle of attack that would otherwise cause flow separation by connecting the highest suction region to the region, or regions of adverse pressure gradient.

2. A method to control the pressure distribution over the surface of a solid body. By controlling the excursion of the center of pressure over the solid body the twisting momentum caused by the lifting force on the body can be limited.

3. A method according to claim 1 where the solid body is a fixed or rotating wing of an aircraft.

4. A method according to claim 1 where the solid body is a blade of a turbine or impeller or other part of a turbomachinery.

5. A method according to claim 1 where the solid body is part of a machine designed to move fluid or control fluid flow.

6. A method wherein the solid body according to claims 1, 3, 4 and 5 include multiple regions that can be collectively or individually connected.

7. A method to add properly sized reservoirs or plenum chambers to one or all of the connected regions.

8. A method to combine claim 1 with any other form of boundary layer control such as steady or periodic blowing or suction.

9. A method to regulate the suction coupling according to claim 1 with a flow control device such as a butterfly valve.
